(19) United States
(12) Patent Application Publication
(10) Pub. No.: US 2015/0167955 A1
(43) Pub. Date: Jun. 18, 2015

(54) APPLIANCE WITH ILLUMINATION SOURCE ACTUATED BY TOUCH SENSITIVE WINDOW FRAME

(71) Applicant: Whirlpool Corporation, Benton Harbor, MI (US)

(72) Inventor: MICHAEL S. SEELEY, SOUTH HAVEN, MI (US)

(73) Assignee: Whirlpool Corporation, Benton Harbor, MI (US)

(21) Appl. No.: 14/132,746

(22) Filed: Dec. 18, 2013

(51) Int. Cl. F21V 33/00; H05B 37/02

(52) U.S. Cl. CPC F21V 33/0044; H05B 37/0209

(57) ABSTRACT

An appliance with a treating chamber and an illumination source selectively actuable to illuminate at least a portion of the treating chamber may include a closure element, such as a door, with a window located on the closure element for viewing of the treating chamber through the window when the closure element closes the treating chamber. A frame for the window may include a touch switch operably coupled to the illumination source such that contact of the frame by a user actuates the touch switch and thereby the illumination source to illuminate at least a portion of the treating chamber.

### BACKGROUND

Many household appliances include a door with a window or other translucent or transparent panel for viewing the interior of the appliance during its operation. For example, a dishwasher can have a window on its door to allow a user to view the dishes while they are being washed, and an oven often has a window on its door to visually observe food as it cooks in the oven cavity. The interior of the appliance, however, can be dark and difficult to see. Consequently, many appliances also include an illumination source to provide light for viewing the interior of the appliance during its operation.

### BRIEF SUMMARY

An appliance conducting a useful cycle of operation on an article according to one embodiment of the invention may comprise a treating chamber receiving the article and having an access opening, an illumination source selectively actuable to illuminate at least a portion of the treating chamber, and a closure element selectively closing at least a portion of the access opening. The closure element may comprise a window located on the closure element enabling viewing of the treating chamber through the window when the closure element closes the at least a portion of the access opening, and a frame at least partially surrounding the window and comprising a touch switch operably coupled to the illumination source such that contact of the frame by a user actuates the touch switch and thereby the illumination source to illuminate at least a portion of the treating chamber.

### BRIEF DESCRIPTION OF THE DRAWINGS

In the drawings:

FIG. 1 is a perspective view of an appliance in the form of a dishwasher according to one embodiment shown with a closure element opened.

FIG. 2 is a schematic view of a control system of the dishwasher of FIG. 1 according to one embodiment.

FIG. 3 is a front view of the dishwasher of FIG. 1 according to one embodiment with the closure element closed.

FIG. 4 is a front view of an alternative closure element for the dishwasher of FIG. 1 according to one embodiment.

FIG. 5 is a schematic view illustrating operative communication between a frame of a window from the closure element of FIG. 3, a touch switch associated with the frame, an illumination system, and the control system for the dishwasher of FIG. 1 according to one embodiment.

FIG. 6 is a schematic view of a user actuating an illumination source of the illumination system of FIG. 5.

FIG. 7 is a schematic view of an alternative arrangement of touch switches associated with the frame of FIG. 5.

FIGS. 8A and 8B are perspective views of an appliance in the form of a laundry treating appliance incorporating an illumination system actuable by a touch switch associated with a window frame on its closure element according to one embodiment.

FIGS. 9A and 9B are a perspective view and a front view, respectively, of an appliance in the form of an oven incorporating an illumination system actuable by a touch switch associated with a window frame on its closure element according to one embodiment.

FIG. 10 is a perspective view of an appliance in the form of a refrigerator incorporating an illumination system actuable by a touch switch associated with a window frame on its closure element according to one embodiment.

### DETAILED DESCRIPTION

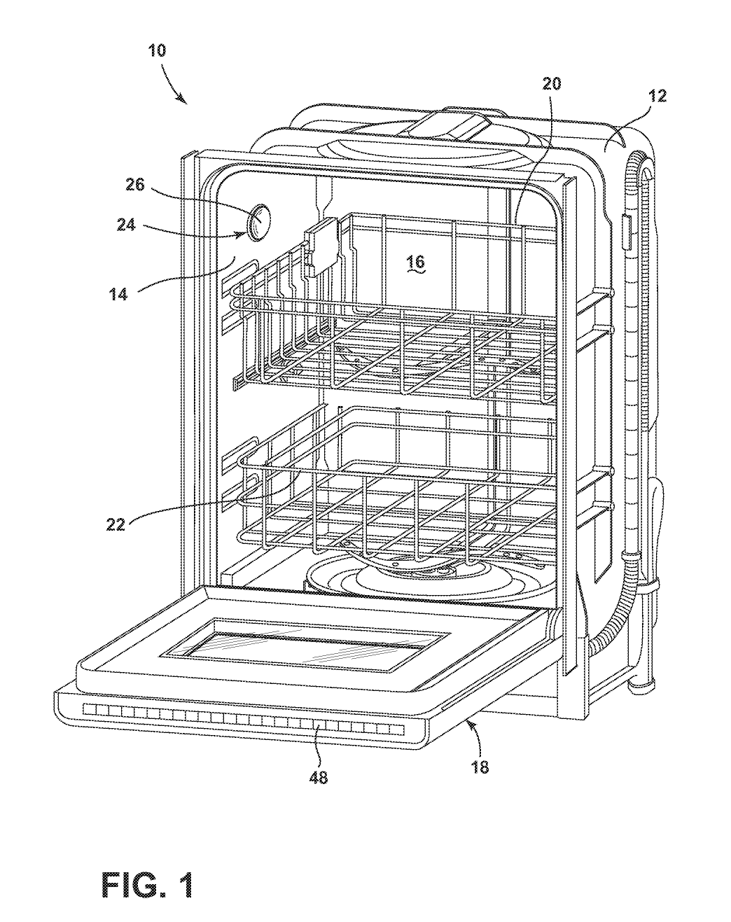

FIG. 1 illustrates a perspective view of an exemplary automated dishwasher 10 according to a first embodiment. The dishwasher 10 shares many features of a conventional automated dishwasher, which will not be described in detail herein except as necessary for a complete understanding of the invention. A chassis 12 may define an interior of the dishwasher 10 and may include a frame, with or without panels mounted to the frame. For built-in dishwashers, outer panels are typically not needed. For dishwashers that are not built into existing cabinetry, the chassis 12 may include the panels mounted to the frame to form a cabinet for the dishwasher 10. An open-faced tub 14 may be provided within the chassis 12 and may at least partially define a treating chamber 16 for washing or otherwise treating dishes. The open face of the tub 14 defines an access opening for the treating chamber 16. A closure element 18, such as a door, may be movably mounted to the dishwasher 10 for movement between opened and closed positions to selectively open and close the treating chamber access opening defined by the open face of the tub 14. Thus, the closure element 18 provides accessibility to the treating chamber 16 for the loading and unloading of dishes or other washable items. The closure element 18 may be pivotally mounted to the chassis 12 for pivotal movement relative to the tub 14, as illustrated. Alternatively, the closure element 18 may be slidable relative to the chassis 12, such as in a drawer-type dishwasher, wherein the access opening for the treating chamber 16 is formed by an open-top tub. Other configurations of the closure element 18 relative to the chassis 12 and the tub 14 are also within the scope of the invention.

Dish holders, illustrated in the form of upper and lower dish racks 20, 22, may be located within the treating chamber 16 and receive dishes for treatment, such as washing. The upper and lower racks 20, 22 are typically mounted for slidable movement in and out of the treating chamber 16 for ease of loading and unloading. Other dish holders may be provided, such as a silverware basket, separate from or combined with the upper and lower racks 20, 22. As used in this description, the term “dish(es)” is intended to be generic to any item, single or plural, that may be treated in the dishwasher 10, including, without limitation, dishes, plates, pots, bowls, pans, glassware, and silverware.

An illumination system 24 with an illumination source 26 may be operable to illuminate at least a portion of the treating chamber 16. The illumination source 26 may be any suitable device that provides illumination to the treating chamber 16. Examples of illumination sources include, but are not limited to, incandescent, fluorescent, light emitting diodes (LED), and high-intensity discharge (HID) lights. The illumination source 26 may be located interiorly or exteriorly of the tub 14. If exteriorly, the tub 14 may have a transmissive portion through which the illumination may pass, or a light distributor, such as a light pipe, light guide, or fiber optic, may be used to distribute the light to the treating chamber 16. The illumination system 24 may optionally include more than one illumination source 26 positioned at different locations or at the same location. The illumination source 26 may be positioned at any suitable location for providing illumination or light to the treating chamber 16, such as on a wall of the tub 14. For illustrative purposes, the illumination source 26 is shown as being located on a side wall of the tub 14, but the illumination source 26 may alternatively be located on a top or rear wall of the tub 14.

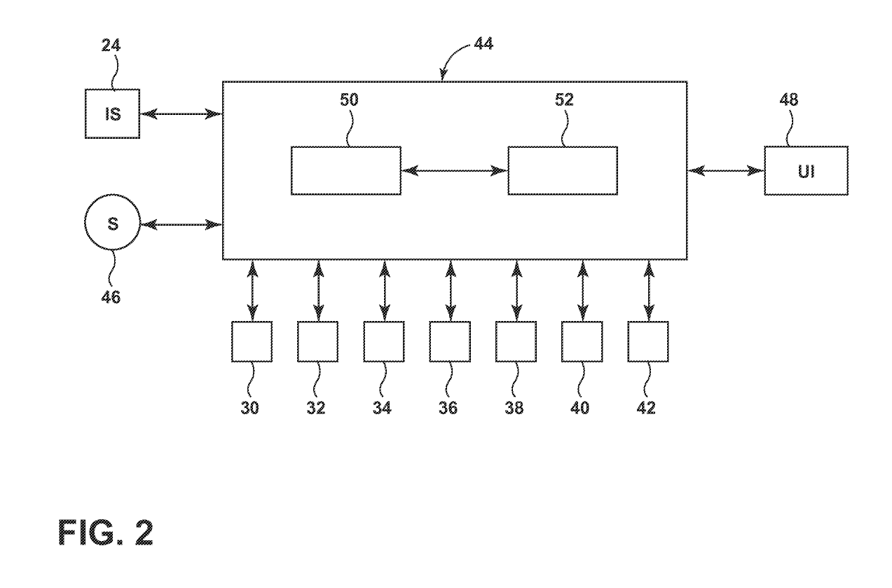

As shown in FIG. 2, which is a schematic view of a control system of the dishwasher 10, the dishwasher 10 may include multiple systems for executing a treating cycle of operation on the dishes. Such systems may include, for example, a liquid supply system 30 that provides liquid from exterior of the dishwasher 10 into the dishwasher 10, a spray system 32 that may spray liquid in the treating chamber 16, a dispensing system 34 that supplies one or more treating agents to the treating chamber 16, a recirculation system 36 that may recirculate liquid from the treating chamber 16 to the spray system 32, a drain system 38 that may drain liquid from the treating chamber 16 to exterior of the dishwasher 10, a heating system 40 that may heat liquid in or supplied to the treating chamber 16, and a drying system 42 that may provide air, which may be heated, to the treating chamber 16. These systems may include, for example, various pumps, valves, diverters, sensors, heaters, filters, sprayers, and other components as needed to execute various treating cycles of operation. The dishwasher 10 may include all of the above exemplary systems, a selection of the above exemplary systems, and/or other systems not listed above as desired. Further, some of the systems may be combined with other systems and/or may share components with other systems.

With continued reference to FIG. 2, the various systems of the dishwasher 10 may operatively communicate with a controller 44 to implement a treating cycle of operation. The illumination system 24 may also operatively communicate with the controller 44, and the controller 44 may also receive input from one or more sensors 46 not associated with a specific system of the dishwasher 10. Non-limiting examples of sensors that may be communicably coupled with the controller 44 include temperature sensors and turbidity sensors. The controller 44 may also be operably coupled with a control panel or user interface 48 for receiving user-selected inputs and communicating information to the user. The user interface 48 may include operational controls such as dials, lights, switches, and displays enabling a user to input commands, such as a treating cycle of operation, to the controller 44 and receive information. The controller 44 may be provided with a memory 50 and a central processing unit (CPU) 52. The memory 50 may be used for storing control software that may be executed by the CPU 52 in completing a treating cycle of operation using the dishwasher 10 and any additional software. For example, the memory 50 may store one or more pre-programmed treating cycles of operation that may be selected by a user and completed by the dishwasher 10. The controller 44 may be located within the closure element 18 or may alternatively be located somewhere within the chassis 12; the location of the controller 44 is not germane to the invention.

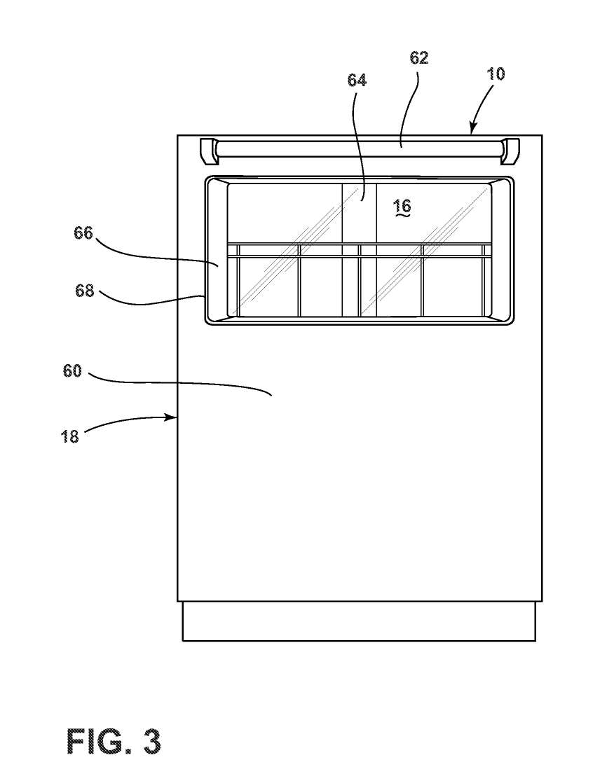

Referring now to FIG. 3, which is a front view of the dishwasher 10, the dishwasher closure element 18 may include an outer panel 60 and a handle 62 mounted to the outer panel 60 to facilitate opening and closing of the closure element 18. The closure element 18 may have any type of handle 62, such as the illustrated bar handle or other type of handle, including a pocket handle; the handle type is not germane to the invention. A window 64 provided on the closure element 18 enables viewing of the treating chamber 16 through the window 64 when the closure element 18 closes the treating chamber access opening. The window 64 may be any suitable type of window and may be formed of any suitable translucent or transparent material or material that may be treated to be at least partially translucent or transparent, such as electrochromic or other smart windows.

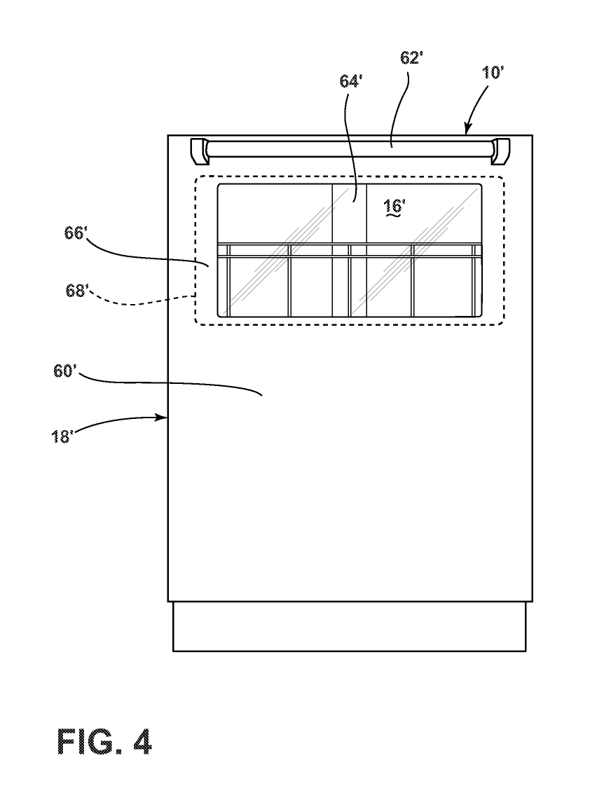

A frame 66 may be provided around the window 64. The frame 66 may have any suitable design and may be configured to complement the shape of the window 64, which may be rectangular, as shown in FIG. 3, or another shape, such as oval, circular, elliptical, square, and the like. The frame 66 may be formed separately from the outer panel 60, as is apparent in FIG. 3 by a line of demarcation 68 between the frame 66 and the outer panel 60. In general, the frame 66 is an area bordering the window 64; however, the frame 66 need not completely circumscribe the window 64 but must encompass a region directly adjacent the window 64. Further, as shown in the alternative embodiment of FIG. 4, which is a front view of the dishwasher 10′ and wherein elements similar to those of the previous embodiment are identified with the same reference numeral bearing a prime (′) symbol, the frame 66′ may be integrally formed with the outer panel 60′ such that a portion of the outer panel 60′ constitutes the frame 66′ without a line of demarcation defining the frame 66′. Optionally, a line of demarcation 68′ may be formed on the outer panel 60′, such as by etching or marking the outer panel 60′, to communicate to a user the boundary of the frame 66′. The illustrative line of demarcation 68′ of the frame 66′ is illustrated in FIG. 4 in phantom, with it being understood that the line of demarcation 68′ may be omitted or formed on the outer panel 60′ as just described.

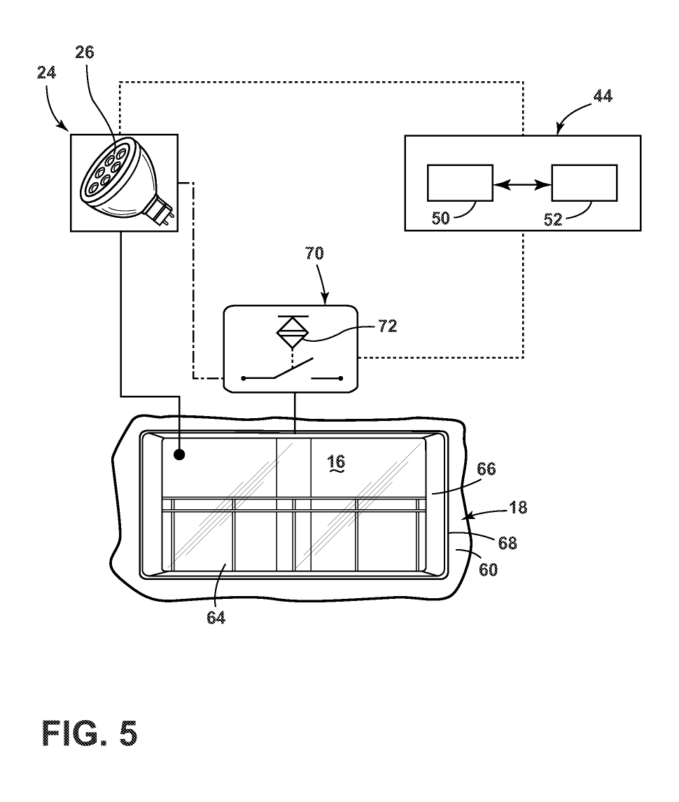

Referring now to the schematic view of the illumination system 24 in FIG. 5, the illumination system 24 may include a touch switch 70 associated with the frame 66 and operatively coupled to the illumination source 26. The touch switch 70 may include a touch sensor 72 positioned to be responsive to a user touching the frame 66. For example, the touch sensor 72 may be mounted directly the frame 66 or to another part of the closure element 18 behind the frame 66 so that the touch sensor 72 is not visible to a user. The touch switch 70 may include a plurality of the touch sensors 72 spaced around the entire frame 66 so that the entire frame 66 may be responsive to the user's touch. Alternatively, the one or more touch sensors 72 may be arranged at specific locations on the frame 66 so as to render only those specific locations responsive to the user's touch. The specific locations that correspond to the touch sensors 72 and are, therefore, responsive the user's touch may be identified as such by any suitable indicia so that the user may be cognizant of the locations that he/she should touch on the frame 66. The touch sensor 72 may be any type of touch-sensitive sensor, such as a capacitance sensor, a resistance sensor, or a piezoelectric sensor, for example, thereby rendering the touch switch 70 a capacitive switch, a resistance switch, or a piezoelectric switch, respectively.

With continued reference to FIG. 5, the touch switch 70 may communicate with the illumination source 26 directly, as illustrated by the dash-dot-dash line, or indirectly through the controller 44, as illustrated by a dashed line, or both. With direct communication, the touch switch 70 may be configured in an electrical circuit that includes the illumination source 26 such that actuation of the touch switch 70 by a user touching the frame 66 in the vicinity of the touch sensor 72 closes or opens the electrical circuit, thereby actuating the illumination source 26 by turning on or off, respectively, the illumination source 26. With indirect communication, the touch switch 70 may be configured to send a signal to the controller 44 upon actuation of the touch switch 70 by a user touching the frame 66 in the vicinity of the touch sensor 72, and the controller 44 may send a command to the illumination source 26 in response to the signal from the touch switch 70 to actuate the illumination source 26. The command to the illumination source 26 may relate to, for example, turning on the illumination source 26, turning off the illumination source 26, changing an intensity of the illumination provided by the illumination source 26, and/or changing a color of the illumination provided by the illumination source 26.

Advantageously, the touch switch 70 is not discernable to the user because the touch surface that is associated with the touch switch 70 for actuation thereof, i.e., the frame 66, is an already existing element of the closure element 18. When a user looks at the closure element 18, the user does not see a dedicated switch to actuate the illumination source 26, thus providing a more aesthetically pleasing appearance for the dishwasher 10. That is, the touch switch 70 at least appears to be visually part of the closure element front panel 60 and/or window 24 and is not noticeable, in the traditional sense, as a touch surface. Optional indicia on the closure element 18 may provide guidance to the user as to where the user must touch the frame 66 to actuate the touch switch 70, but, nonetheless, the frame 66 itself is the touch surface for the touch switch 70, and the touch switch 70 is not visible to the user. To achieve this hidden appearance, for example, the frame 66 may be constructed as part of the touch switch 70 with the touch sensor 72 mounted directly behind the frame 66, such as to the rear surface of the frame 66, which may be the rear surface of the outer panel 60 if the frame 66 is integrally formed with the outer panel 60.

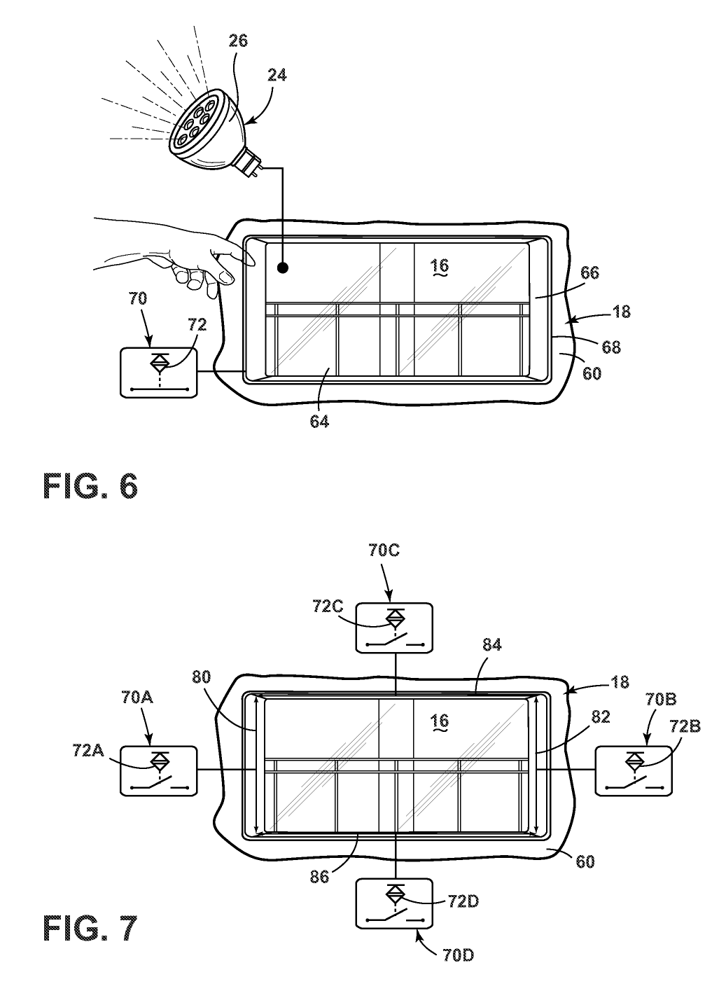

An exemplary description of the operation of the illumination source 26 follows, with the assumption, for exemplary purposes, that the illumination source 26 is initially off. Referring additionally to FIG. 6, a user who desires to view the treating chamber 16 while the closure element 18 closes the access opening approaches the closure element 18 and touches the frame 66 for the window 64. If the touch sensors 72 extend around the entire frame 66, then the user may touch any location on the frame 66 to actuate the touch switch 70, whereas if the touch sensor(s) 72 are positioned at a specific location on the frame 66, the user must touch that specific location on the frame 66 to actuate the touch switch 70. Once the user touches the frame 66, the sensor(s) 72 sense the touch, thereby actuating the touch switch 70, which, in turn, actuates the illumination source 26, through the direct or indirect communication routes described above, to turn on and illuminate at least a portion of the treating chamber 16, which the user can view through the window 64.

Optionally, the manner in which the user touches the frame 66 may change one or more qualities or properties of the illumination provided by the illumination source 26. For example, the user may hold their finger on the frame 66 for a period of time longer than a single touch or tap. The touch sensor(s) 72 may sense the duration of the touch, and the touch switch 70 then actuates the illumination source 26 to change the intensity of the illumination provided thereby, similar to a dimmer switch. The degree of the change in the intensity may optionally correspond to the duration that the finger is held on the frame 66. For example, the intensity may increase as the duration increases. Other actions, such as swiping or sliding a finger along a length of the frame 66, may also be employed for changing the intensity of the illumination from the illumination source 26, similar to a dimmer switch. In such a configuration, the degree of the change in the intensity may optionally correspond to the distance along which the user swipes or slides the finger on the frame 66 or the direction the user swipes or slides the finger on the frame 66. As examples, the intensity may increase as the distance increases, or the intensity may increase as the user swipes in a first direction and decrease as the user swipes in a second direction, perhaps opposite the first direction. In another example, holding a touch on the frame 66 and/or swiping or sliding a finger on the frame 66 may change a color of the illumination provided by the illumination source 26. A color change may also occur in response to a single touch on the frame 66.

When the user no longer wishes to view the treating chamber 16 through the window 64, the user may again touch the frame 66. The sensor(s) 72 sense the touch, thereby actuating the touch switch 70, which, in turn, actuates the illumination source 26, through the direct or indirect communication routes described above, to turn off. Optionally, the illumination source 26 may turn off after a predetermined period of time if the user neglects to manually turn off the illumination source 26 by touching the frame 66.

The frame 66 and the illumination system 24 may be configured in any suitable manner to provide desired illumination of the treating chamber 16 and a desired user interaction with the frame 66 for illuminating the treating chamber 16. As mentioned above, the one or more touch sensors 72 may be arranged at specific locations on the frame 66 so as to render only those specific locations responsive to the user's touch. Additionally, multiple touch switches 70, each having one or more than one touch sensor 72, may be associated with various locations of the frame 66, and each of the touch switches 70 may optionally correspond to an independent actuation of the illumination source 26. An example of such a configuration is shown in FIG. 7. The exemplary frame 66 is generally rectangular with four sides, a pair of generally vertical sides 80, 82 and a pair of generally horizontal sides 84, 86, each having a corresponding length. Each of the sides 80, 82, 84, 86 may be associated with its own touch switch 70A, 70B, 70C, 70D, respectively, such that a user touching, whether by a single touch, a multiple touch (e.g., double or triple tap), a holding touch, a moving touch (e.g., swiping/sliding touch), or other type of touch, one of the sides 80, 82, 84, 86, either anywhere on the entire length or a specific location depending on the arrangement of the touch sensors 72A, 72B, 72C, 72D on the sides 80, 82, 84, 86, will actuate the touch switch 70A, 70B, 70C, 70D corresponding to the touched side 80, 82, 84, 86. For example, the touch switch 70A may be configured to turn the illumination source 26 on and off, while the touch switch 70B may be configured to change the intensity of the illumination source 26, and the touch switch 70C may be configured to turn a color of the illumination source 26 on and off, while the touch switch 70D may be configured to change the color of the illumination source 26.

The touch switches 70A, 70B, 70C, 70D may be also be configured to actuate the same functions of the illumination source 26 rather than independent functions. For example, the touch switches 70A, 70B may both be configured to turn the illumination source 26 on and off and change the intensity of the illumination, while the touch switches 70C, 70D may both be configured to change the color of the illumination from the illumination source 26. Further, the touch switches 70A, 70B, 70C, 70D may be configured to actuate both shared and independent functions. In an exemplary example, all of the touch switches 70A, 70B, 70C, 70D may be configured to turn the illumination source 26 on and off, 70A and/or 70B may be configured to change the intensity of the illumination, and 70C and/or 70D may be configured to change the color of the illumination.

It is also contemplated that the sides 80, 82, 84, 86 may be associated with the same touch switches 70. For example, the sides 80, 82 may both be associated with the touch switch 70A (70B would be omitted), wherein the touch switch 70A would include sensors 72A on both of the sides 80, 82, while the sides 84, 86 may both be associated with the touch switch 70C (70D would be omitted), wherein the touch switch 70C would include sensors 72C on both of the sides 84, 86. The touch switches 70A, 70C may be configured to actuate shared and/or independent functions of the illumination source 26, as described above. Numerous quantities and arrangements of the touch switches 70 and touch sensors 72 on the frame 66 and numerous assignments of illumination source functions to the touch switches 70 are feasible.

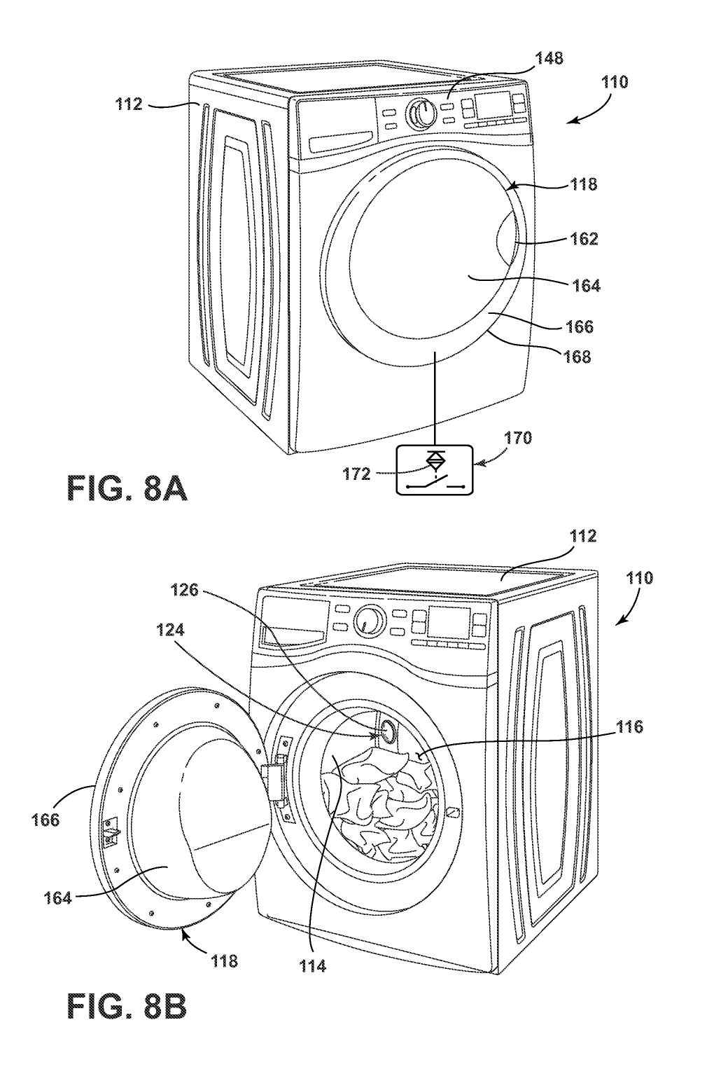

The illumination system 24 with the illumination source 26 actuable by the touch switch 70 associated with the window frame 66 on the closure element 18 may be incorporated into other types of household appliances for which it is desirable for a user to view the treating chamber 16 when the closure element 18 is closed. Examples of other types of appliances include, but are not limited to, a laundry treating appliance, such as a washing machine and a dryer, an oven, such as a conventional oven and a microwave oven, and a refrigerator and/or freezer. Some of these exemplary appliances as illustrated in FIGS. 8A-10, wherein elements similar to those in previous embodiments are identified with the same reference numeral bearing a distinguishing lead numeral (e.g., 10 becomes 110, 210, 310).

FIGS. 8A and 8B illustrate a laundry treating appliance 110 having a drum 114 that defines a treating chamber 116. The drum 114 may be perforated or non-perforated, depending on the type of treating cycle of operation to be performed on laundry in the treating chamber 116. Exemplary treating cycles of operation include, but are not limited to, washing, rinsing, drying, sanitizing, refreshing, wrinkle removal, and the like. The drum 114 may be oriented generally horizontally, as shown, or may be vertically oriented, commonly referred to as a basket in a vertical orientation, and may be held by a tub when perforated. A generally circular or round frame 166 surrounds a generally circular or round window 164 on a closure element 118. An illumination system 124 including an illumination source 126 may be operatively coupled to one or more touch switches 170 having one or more touch sensors 172 associated with the frame 166. The configuration and operation of the illumination system 124 may be similar to that described above for the dishwasher 10.

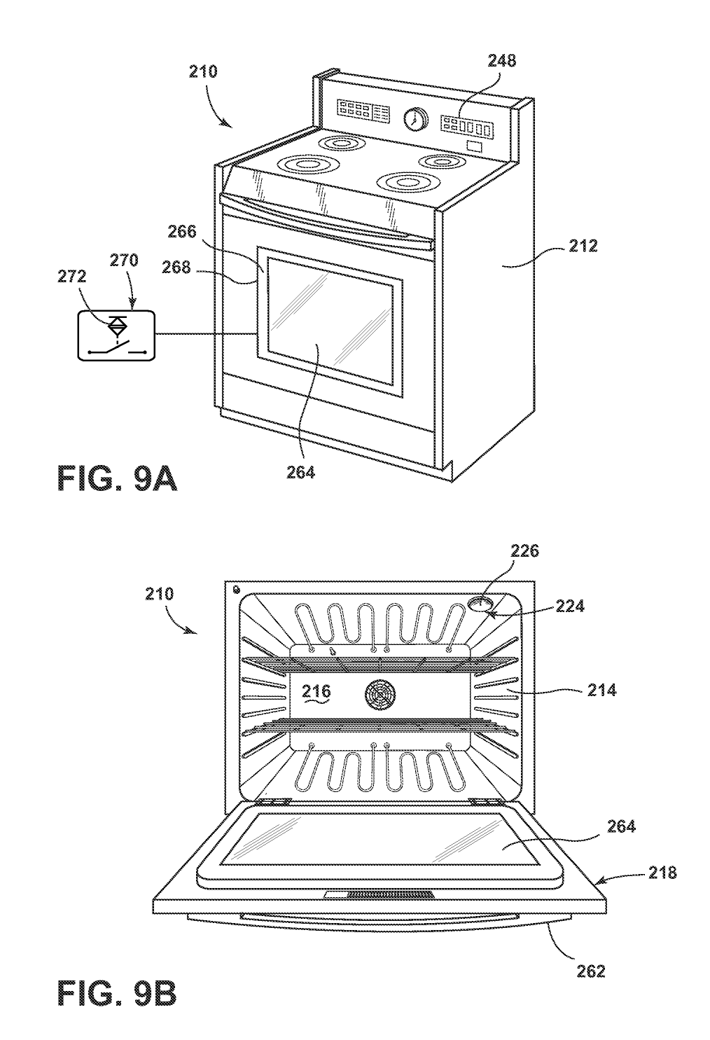

FIGS. 9A and 9B illustrate a conventional oven 210 having a cabinet 214 defining a treating chamber 216 that may receive food for treatment. Exemplary treating cycles of operation include, but are not limited to, baking, broiling, warming, and the like. A frame 266 surrounds a window 264 on a closure element 218. An illumination system 224 including an illumination source 226 may be operatively coupled to one or more touch switches 270 having one or more touch sensors 272 associated with the frame 266. The configuration and operation of the illumination system 224 may be similar to that described above for the dishwasher 10. A microwave oven having a cabinet defining a treating chamber that receives food for treatment may also include a similar system for actuating an illumination source.

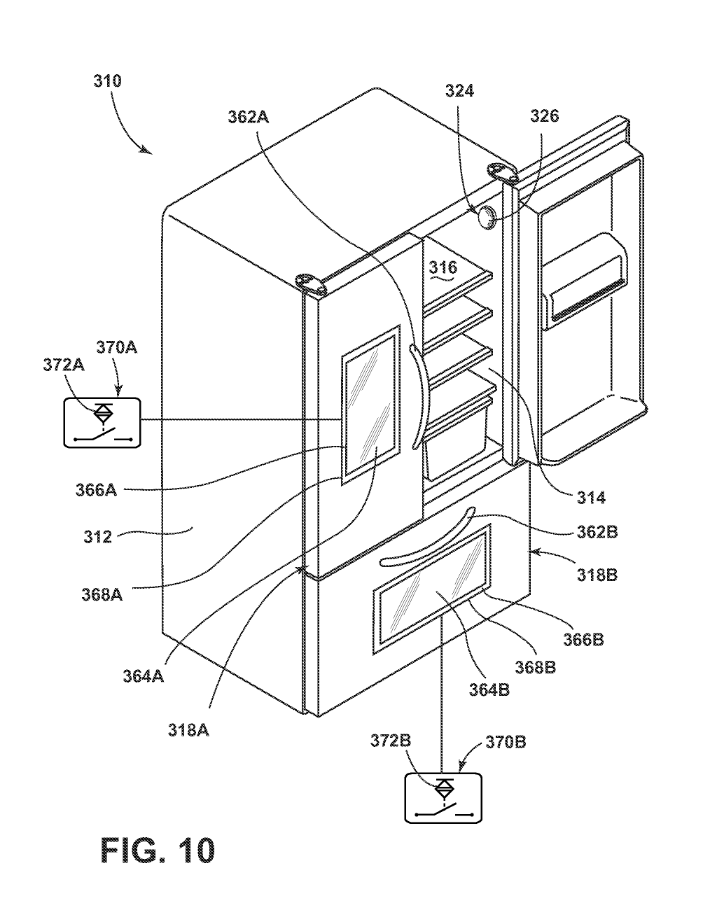

FIG. 10 illustrates a refrigerator 310 having a cabinet 314 defining a treating chamber 316 that may receive food for treatment. An exemplary treating cycle of operation is a cooling or refrigeration cycle. A frame 366A surrounds a window 364A on a closure element 318A. An illumination system 324 including an illumination source 326 may be operatively coupled to one or more touch switches 270A having one or more touch sensors 272A associated with the frame 266A. The configuration and operation of the illumination system 224 may be similar to that described above for the dishwasher 10. The refrigerator 310 may further include another closure element 318B for an additional treating chamber that may perform a freezing cycle of operation. A frame 366B surrounds a window 364B on the closure element 318B. The illumination system 324 including the illumination source 326 may be operatively coupled to one or more touch switches 270B having one or more touch sensors 272B associated with the frame 266B. Alternatively, the appliance may be a stand-alone refrigerator without a freezer or a stand-alone upright or chest freezer.

While the invention has been specifically described in connection with certain specific embodiments thereof, it is to be understood that this is by way of illustration and not of limitation, and the scope of the appended claims should be construed as broadly as the prior art will permit.

What is claimed is:

1. An appliance conducting a useful cycle of operation on an article, the appliance comprising:
a treating chamber receiving the article and having an access opening;
an illumination source selectively actuable to illuminate at least a portion of the treating chamber;
a closure element selectively closing at least a portion of the access opening and comprising:
a window located on the closure element enabling viewing of the treating chamber through the window when the closure element closes the at least a portion of the access opening; and
a frame at least partially surrounding the window and comprising a touch switch operably coupled to the illumination source such that contact of the frame by a user actuates the touch switch and thereby the illumination source to illuminate at least a portion of the treating chamber.

2. The appliance according to claim 1 wherein the closure element comprises an outer panel, and the frame is integrally formed with the outer panel.

3. The appliance according to claim 1 wherein the closure element comprises an outer panel, and the frame is formed separately from the outer panel.

4. The appliance according to claim 1 wherein the window and the frame are rectangular.

5. The appliance according to claim 1 wherein the window and the frame are round.

6. The appliance according to claim 1 wherein the touch switch comprises at least one of a capacitance switch, a resistance switch, and a piezoelectric switch.

7. The appliance according to claim 1 wherein only a portion of the frame is operatively associated with the touch switch such that the touch switch is actuated only when the user touches the portion of the frame operatively associated with the touch switch.

8. The appliance according to claim 1 wherein the entire frame is operatively associated with the touch switch such that the touch switch is actuated when the user touches any portion of the frame.

9. The appliance according to claim 8 wherein the touch switch comprises multiple touch sensors spaced about the frame.

10. The appliance according to claim 1 wherein a first length of the frame is operatively associated with the touch switch such that a user sliding a finger at least partially along the first length actuates the touch switch to change an intensity of illumination emitted from the illumination source.

11. The appliance according to claim 10 wherein the frame comprises an additional touch switch, and a second length of the frame is operatively associated with the additional touch switch such that a user sliding a finger at least partially along the second length actuates the additional touch switch to change a color of illumination emitted from the illumination source.

12. The appliance according to claim 11 wherein the frame is generally rectangular defining multiple sides, and one of the first and second lengths of the frame is on a first one of the multiple sides, and the other of the first and second lengths of the frame is on a second one of the multiple sides.

13. The appliance according to claim 12 wherein the first one of the multiple sides is vertically oriented, and the second one of the multiple sides is horizontally oriented.

14. The appliance according to claim 1 wherein a length of the frame is operatively associated with the touch switch such that a user sliding a finger along the length actuates the touch switch to change a color of light emitted from the illumination source.

15. The appliance according to claim 1 wherein the illumination source is selectively actuable between on and off conditions in response to the user contact of the frame.

16. The appliance according to claim 15 wherein a duration of the user contact of the frame changes the intensity of light emitted from the illumination source.

17. The appliance according to claim 1 wherein the appliance is at least one of a dishwasher having a tub that defines the treating chamber, a laundry treating appliance having a drum that defines the treating chamber, an oven having a cabinet that defines the treating chamber, and a refrigerator having a cabinet that defines the treating chamber.

18. The appliance according to claim 1 wherein the frame comprises a plurality of the touch switches operably coupled to the illumination source.

19. A method of illuminating a treating chamber in an appliance conducting a useful cycle of operation on an article in the treating chamber, the appliance comprising an illumination source selectively actuable to illuminate at least a portion of the treating chamber, a closure element selectively closing an access opening for the treating chamber and having a window enabling viewing of the treating chamber through the window when the closure element closes the access opening and a frame at least at least partially surrounding the window, the method comprising:
sensing a touch on the frame; and
actuating the illumination source in response to the sensed touch.

20. The method of claim 19 wherein the actuating of the illumination source comprises turning the illumination source on.

21. The method of claim 20, further comprising sensing a second touch on the frame and turning the illumination source off in response to the second touch.

22. The method of claim 19 wherein the actuating of the illumination source comprises changing an intensity of illumination from the illumination source.

23. The method of claim 19 wherein the actuating of the illumination source comprises changing a color of illumination from the illumination source.

24. The method of claim 19 wherein the sensing of the touch on the frame comprises sensing a duration of the touch on the frame.

25. The method of claim 19 wherein the sensing of the touch on the frame comprises sensing a sliding touch on the frame.

26. The method of claim 19 wherein when the touch on the frame occurs at a first location on the frame, the actuating of the illumination source comprises changing a first property of the illumination source, and when the touch on the frame occurs at a second location on the frame, the actuating of the illumination source comprises changing a second property of the illumination source.

27. The method of claim 26 wherein the first property of the illumination source is the illumination intensity, and the second property of the illumination source is the illumination color.
